(19) United States
(12) Patent Application Publication
(10) Pub. No.: US 2016/0302486 A1
(43) Pub. Date: Oct. 20, 2016

(54) Electric Heating Cartridge for a Dry Herb Vaporizer

(71) Applicant: Eli Eroch, Hollywood, FL (US)

(72) Inventor: Eli Eroch, Hollywood, FL (US)

(73) Assignee: ATMOS NATION, LLC, Davie, FL (US)

(21) Appl. No.: 14/488,970

(22) Filed: Sep. 17, 2014

(51) Int. Cl. A24F 47/00; H05B 3/42; H05B 3/14

(52) U.S. Cl. CPC A24F 47/008; H05B 3/141; H05B 3/42

(57) ABSTRACT

An electric heating cartridge for dry herb vaporizers has a heating assembly, a battery connector, and a connector insert enclosed by a cartridge sleeve. The battery connector provides a means for attaching the electric heating cartridge to a power source, while a mouthpiece is attached via the connector insert. The heating assembly includes a heating element, a heating chamber, a lower heat insulator, and an upper heat insulator. The heating element is positioned within the heating chamber and powered through the battery connector, wherein herbs are heated within the heating chamber. The heating chamber is positioned in between the lower heat insulator and the upper heat insulator, wherein the lower heat insulator and the upper heat insulator dissipate heat from the heating chamber and the heating element. Ideally, the heating element has a ceramic heater body with at least one heating coil embedded in the heater body.

### FIELD OF THE INVENTION

The present invention relates generally to an apparatus for smoking. More specifically, the present invention is a heating apparatus for use in dry herb vaporizers to release active chemicals in herbs and other substances.

### BACKGROUND OF THE INVENTION

Smoking is a widely practiced route of administration that involves the combustion of herbs in order to release active substances found in said herbs. The product of the combustion is then inhaled and absorbed through the lungs. Although many methods and mechanisms of smoking herbs currently exist, by far the most common is the cigarette. Cigarettes generally comprise a quantity of tobacco that is packed tightly into a cylindrical sealed rolling paper. One end of the cigarette is lit in order to combust the tobacco and release nicotine from the tobacco leaves. While tobacco cigarettes are most commonly smoked this way, many other loose herbs may be packed and rolled for consumption by smoking. Despite the prevalence of smoking, many health hazards and risks have become associated with the practice of consuming herbs by smoking. Modern medical studies have successfully linked a plethora of medical problems to smoking including many cancers, heart attacks/diseases, emphysema, infertility, and birth defects, among others. Many of these medical problems are caused by the toxic and carcinogenic products that are found in smoke. Several alternatives to rolling papers exist for smoking including pipes, hookahs, and bongs. However, the vast majority of these alternative methods of smoking still involve the combustion of herbs resulting in toxic and carcinogenic smoke.

Vaporization is an alternative to burning that is generally regarded as a safer alternative, as a vaporizer extracts active ingredients form herbs without releasing the many toxins and carcinogens found in smoke. Although produced vapor still contains trace amounts of tar and noxious gases, the overall method is seen as a safer alternative to the full combustion of herbs. Despite the apparent lowered risk of vapor inhalation relative to smoke inhalation, a common practice is to alternate between the various methods of consuming herbs, often simply as a result of convenience. The present invention seeks to enhance and improve upon currently existing methods and accessories for consuming herbs.

The present invention is an improved and versatile electric heating cartridge for dry herb vaporizers. The electric heating cartridge comprises a ceramic heating chamber and a ceramic heating element positioned within a cartridge sleeve. The ceramic heating element is vertically positioned within the heating chamber providing optimal heat distribution to herbs placed within the heating chamber. Herbs placed into the ceramic heating chamber come into direct contact with the ceramic heating element, wherein the herbs are heated causing active chemicals in the herbs to vaporize. Air is pulled through a plurality of ventilation holes in the cartridge sleeve and a plurality of airflow holes in the heating chamber, wherein the air mixes with the vapor and can be inhaled by a user.

### BRIEF DESCRIPTION OF THE DRAWINGS

FIG. 1 is a perspective view of the present invention; and

FIG. 2 is a sectional view thereof.

FIG. 3 is a front sectional view of the present invention; and

FIG. 4 is a close-up view thereof with reference to the region outlined by the dotted lines in FIG. 3.

FIG. 5 is an exploded view of the present invention.

FIG. 6 is a perspective view of the lower heat insulator.

FIG. 7 is a perspective view of the heating chamber.

FIG. 8 is a front sectional view of the heating chamber.

FIG. 9 is a front elevational view of the heating element, wherein the at least one heating coil is embedded in the outer surface of the heater body.

FIG. 10 is a front sectional view of the heating element, wherein the at least one heating coil is fully embedded within the heater body.

FIG. 11 is a front sectional view of the heating element, wherein the at least one heating coil is embedded into the inner surface of the heater body.

FIG. 12 is a diagram showing the electrical connections between the heating element and the battery pin, more specifically between the battery pin and both the first lead and the second lead.

FIG. 13 is an exploded view of the present invention, wherein the heating element is a cylindrical heating element.

FIG. 14 is an exploded view of the present invention, wherein the heating element is a circular flat head heating element.

FIG. 15 is an exploded view of the present invention, wherein the heating element is a doughnut shaped heating element.

FIG. 16 is a flowchart describing a method for providing an electric heating cartridge; and

FIG. 17 is a flowchart thereof, further detailing embodiments of the heating element provided for the electronic heating cartridge.

### DETAIL DESCRIPTIONS OF THE INVENTION

All illustrations of the drawings are for the purpose of describing selected versions of the present invention and are not intended to limit the scope of the present invention.

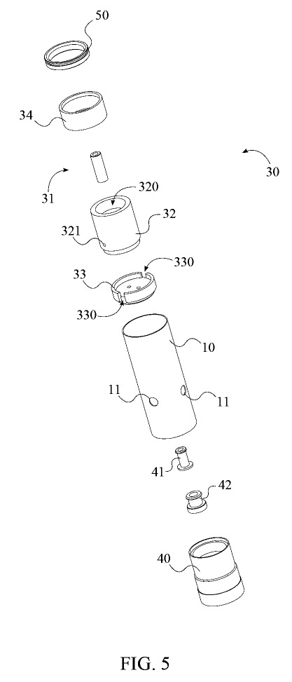

The present invention is an electric heating cartridge for a dry herb vaporizer that is used for heating herbs in order to release active substances in vapor form, wherein the produced vapor is inhaled by a user. The present invention comprises a cartridge sleeve 10, a perimeter gap 20, a heating assembly 30, a battery connector 40, and a connector insert 50; the cartridge sleeve 10, the perimeter gap 20, the heating assembly 30, the battery connector 40, and the connector insert 50 being concentrically aligned with each other, as depicted in FIG. 5. The electric heating cartridge is designed to be used in conjunction with a mouthpiece and a power source connected via the connector insert 50 and battery connector 40 respectively.

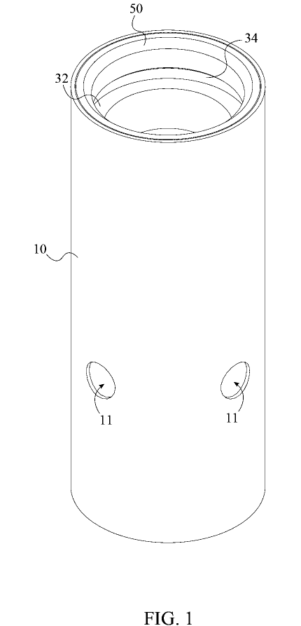

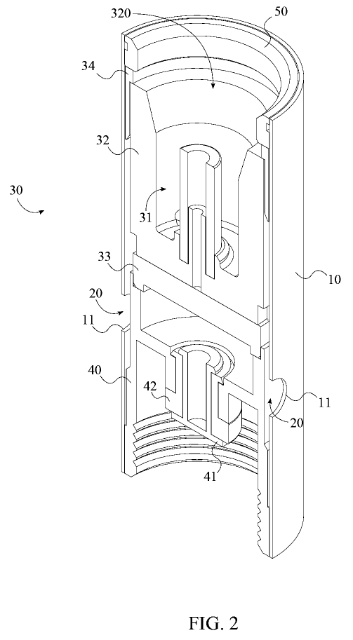

In reference to FIG. 1-2, the cartridge sleeve 10 is the housing structure that encases the heating assembly 30, the battery connector 40, and the connector insert 50. The heating assembly 30 is positioned adjacent to the battery connector 40, while the connector insert 50 is positioned adjacent to the heating assembly 30 opposite the battery connector 40. The perimeter gap 20 is positioned in between the cartridge sleeve 10 and the battery connector 40. The perimeter gap 20 provides an empty volume of space between the cartridge sleeve 10 and the battery connector 40 through which air may flow in order to allow for the inhalation of vapor from the heating of herbs by the heating assembly 30. In the preferred embodiment of the present invention, the cartridge sleeve 10 is a cylindrical sleeve that encases the heating assembly 30, the battery connector 40, and the connector insert 50; the heating assembly 30, battery connector 40, and connector insert 50 being cylindrical as well. However, it is possible for the cartridge sleeve 10, the heating assembly 30, the battery connector 40, and the connector insert 50 to be any other shape.

In reference to FIG. 2, the cartridge sleeve 10 comprises a plurality of ventilation holes 11; each of the plurality of ventilation holes 11 laterally traversing through the cartridge sleeve 10. The plurality of ventilation holes 11 is positioned around the cartridge sleeve 10 adjacent to the perimeter gap 20, wherein the heating assembly 30 is in fluid communication with the plurality of ventilation holes 11 through the perimeter gap 20. Air is pulled through the plurality of ventilation holes 11, through the perimeter gap 20, and through the heating assembly 30 in order to allow herbs to be heated in order to vaporize active chemicals within the herbs.

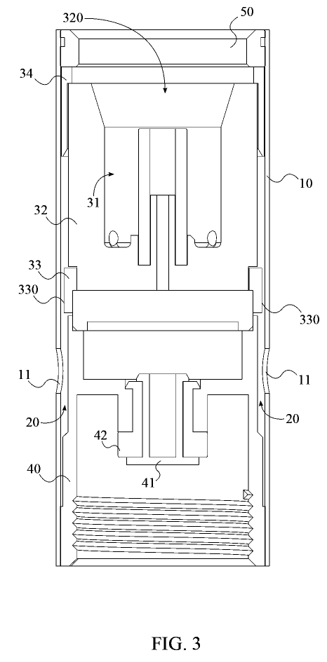

In reference to FIG. 2-3, the battery connector 40 provides a means for connecting the electric heating cartridge to an electric power source, such as a battery; wherein the battery provides electrical current for powering the heating assembly 30. In the preferred embodiment of the present invention, the battery connector 40 is internally threaded opposite the heating assembly 30. The internal threading of the battery connector 40 allows the electric heating cartridge to be attached to a threaded portion of the power source. The internal threading of the battery connector 40 can be either male or female. In an alternative embodiment of the present invention, the battery connector 40 casing provides a means for frictionally securing the power source to the battery connector 40 casing. In addition to the means of connection described above, the battery connector 40 casing may be attached to the power source in any other suitable manner.

In further reference to FIG. 2-3, the battery connector 40 comprises a battery pin 41 and a battery pin insulator 42; the battery pin 41 and the battery pin insulator 42 being concentrically positioned within the battery connector 40. The battery pin insulator 42 is an open-ended, tubular member with an inner circumference sized to receive the battery pin 41. The battery pin 41 is concentrically positioned through the battery pin insulator 42, wherein the battery pin 41 is retained by the battery pin insulator 42. In addition to retaining the battery pin 41 in place within the battery connector 40, the battery pin insulator 42 electrically insulates the battery pin 41. Ideally, the battery pin insulator 42 is constructed from silicone, however, it is possible for any other suitable material having similar properties to be used.

In the preferred embodiment of the present invention, the battery pin 41 is a cylindrical member having a flat circular plate on the bottom end; the flat circular plate being positioned opposite the heating assembly 30 along the battery pin 41. The battery pin 41 comprises a positive contact and a negative contact. The positive contact is positioned on the bottom surface of the flat circular plate, while the negative contact is positioned around the lateral surface of the flat circular plate. The battery pin 41 is not limited to this specific configuration of the positive contact and the negative contact, as the positions of the positive contact and the negative contact can be switched or changed altogether (e.g. both the positive contact and the negative contact can be positioned on the bottom of the flat circular plate with separation between the two). The positive contact and the negative contact of the battery pin 41 engage similar contacts on the attached power source, which in turn forms an electrical circuit between the electric heating cartridge and the power source.

The heating assembly 30 is positioned within the cartridge sleeve 10, adjacent to the battery connector 40, wherein the heating assembly 30 resides above the battery connector 40. Current is provided from the power source to the heating assembly 30 through the battery connector 40 in order to operate the heating assembly 30. The heating assembly 30 allows herbs and other substances to be heated in order to release active chemicals and produce a vapor that can in turn be inhaled by the user. The heating assembly 30 comprises a lower heat insulator 33, a heating element 31, a heating chamber 32, and an upper heat insulator 34.

The lower heat insulator 33 is concentrically positioned within the cartridge sleeve 10, adjacent to the battery connector 40, as shown in FIG. 3. The lower heat insulator 33 rests on top of the battery connector 40 and supports the heating chamber 32. Additionally, the lower heat insulator 33 thermally insulates the cartridge sleeve 10 from the heating chamber 32. This allows the user to safely handle the electric heating cartridge (i.e. touch the cartridge sleeve 10) as the heating element 31 is being utilized to heat substances. In the preferred embodiment of the present invention, the lower heat insulator 33 is constructed from silicone rubber; however, it is possible for the lower heat insulator 33 to be constructed from any other material(s).

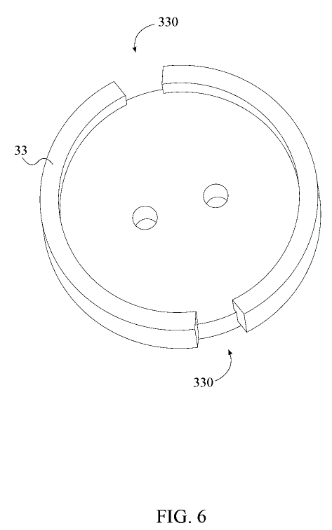

In reference to FIG. 6, the lower heat insulator 33 comprises an at least one perimetric opening 330. The at least one perimetric opening 330 traverses through the lower heat insulator 33 from the top surface of the lower heat insulator 33 to the bottom surface of the lower heat insulator 33. The at least one perimetric opening 330 is positioned adjacent to the perimeter gap 20 due to the placement of the at least one perimetric opening 330 around the perimeter of the lower heat insulator 33. In this way, the at least one perimetric opening 330 is in fluid communication with the perimeter gap 20, thus allowing air pulled through the plurality of ventilation holes 11 to flow through the lower heat insulator 33 to the heating chamber 32. The at least one perimetric opening 330 may or may not be vertically aligned with the plurality of ventilation holes 11.

The heating chamber 32 is both concentrically positioned within the cartridge sleeve 10 and positioned adjacent to the lower heat insulator 33, wherein the lower heat insulator 33 is positioned in between the heating chamber 32 and the battery connector 40. The lower heat insulator 33 has a shallow indented portion about the top surface into which the heating chamber 32 is placed and in turn supported by the lower heat insulator 33. In the preferred embodiment of the present invention, the heating chamber 32 is ceramic; however, it is possible for the heating chamber 32 to be constructed using any other material(s).

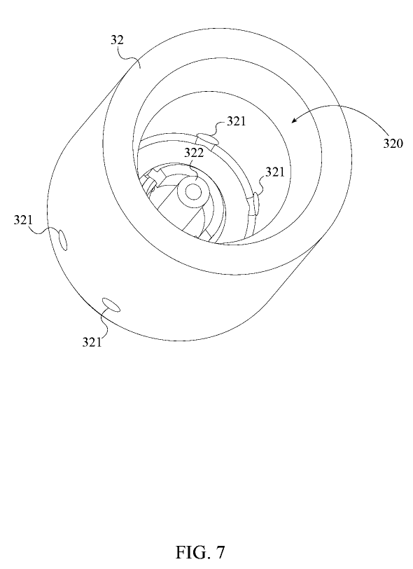

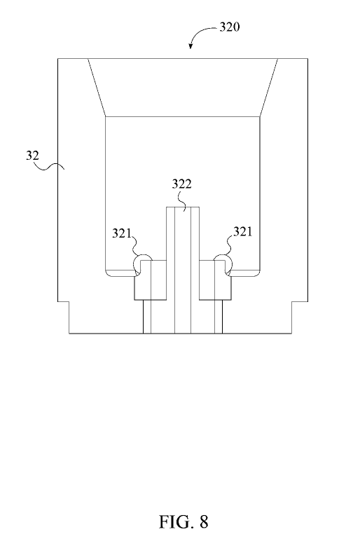

In reference to FIG. 7-8, the heating chamber 32 is a cup-like fixture in which substances, such as herbs, can be heated in order to release active chemicals in vapor form. The heating chamber 32 comprises a chamber opening 320 and a plurality of airflow holes 321; the plurality of airflow holes 321 being positioned around the heating chamber 32 opposite the chamber opening 320. The chamber opening 320 is positioned about the heating chamber 32 opposite the battery connector 40, such that herbs, or other combustible materials, can be positioned through the chamber opening 320 into the heating chamber 32 when the heating chamber 32 is positioned into the lower heat insulator 33. The lower heat insulator 33 being positioned in between the heating chamber 32 and the battery connector 40, prevents the battery connector 40 or the power source from overheating when the heating element 31 is being operated.

The at least one perimetric opening 330 is in fluid communication with both the plurality of airflow holes 321 and the perimeter gap 20. In this way, the plurality of airflow holes 321 is in fluid communication with the plurality of ventilation holes 11 through the at least one perimetric opening 330 and the perimeter gap 20. As herbs are heated within the heating chamber 32 to vaporize active chemicals within the herbs, air is pulled into the electric heating cartridge. The air is pulled though the plurality of ventilation holes 11 and then travels through the perimeter gap 20, the perimetric opening of the lower heat insulator 33, and the plurality of airflow holes 321, where the air is mixed with the vapor and inhaled by the user.

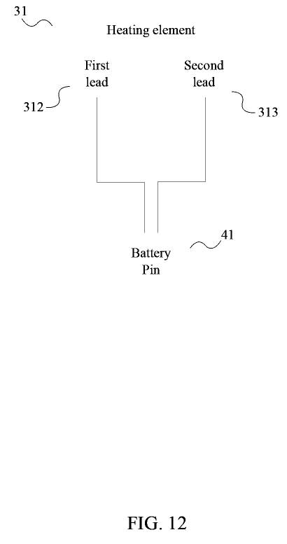

In reference to FIG. 3, the heating element 31 is concentrically positioned within the heating chamber 32 and electrically connected to the battery pin 41, as depicted by FIG. 12. The heating element 31 provides a heat source for combusting substances and comprises a heater body 310, an at least one heating wire 311, a first lead 312, and a second. The heater body 310 is an elongated, tubular member that is attached to the heating chamber 32. The heating chamber 32 further comprises a heater mount 322, wherein the heater mount 322 is concentrically positioned within the heating chamber 32 opposite the chamber opening 320 and provides a connection point for the heating element 31. The heater body 310 is adjacently attached to the heater mount 322 and, more specifically, the heater body 310 is positioned around the heater mount 322.

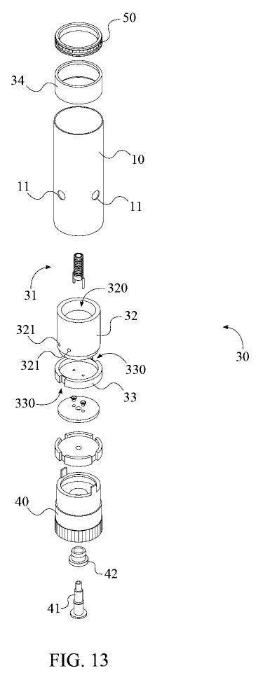

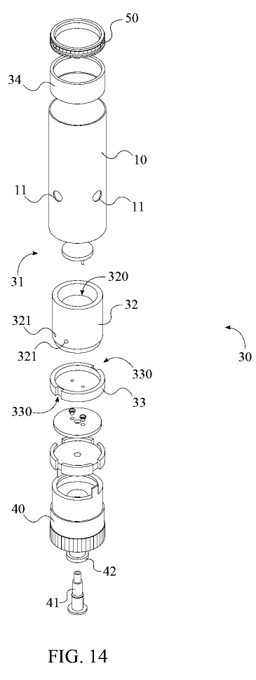

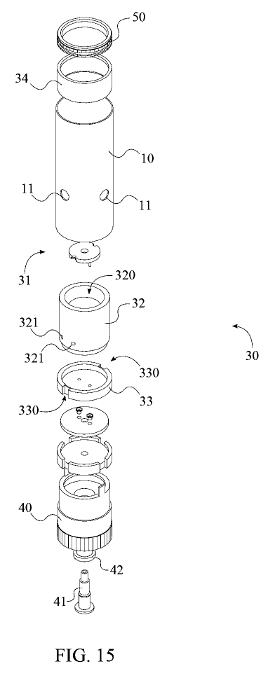

The heating element 31 is axially and slidably positioned within the heating chamber 32, wherein the heating element 31 is removable from the heating chamber 32. The heating element 31 can be slidably positioned into and out of the heating chamber 32 in order to mechanically and electrically connect the heating element 31 to the electric heating cartridge, wherein the first lead 312 and the second lead 313 traverse through the heating chamber 32 and the lower heat insulator 33. In the preferred embodiment of the present invention, the heating element 31 is a cylindrical heating element, as shown in FIG. 13. The cylindrical heating element extends vertically within the heating chamber 32, wherein the cylindrical heating element is axially aligned with the heating chamber 32. It is also possible for the heating element 31 to have different shapes. For example, in an alternative embodiment of the present invention, the heating element 31 is a circular flat head heating element, as shown in FIG. 14. In another alternative embodiment of the present invention, the heating element 31 is a doughnut shaped heating element, as shown in FIG. 15.

The first lead 312 and the second lead 313 are adjacently connected to the heater body 310 and provide the means by which the heating element 31 is electrically connected to the battery pin 41, as depicted in FIG. 12. The at least one heating wire 311 is embedded in the heater body 310 and adjacently connected to both the first lead 312 and the second lead 313. In this way, current is passed through the at least one heating wire 311 when the power source attached to the electric heating cartridge is activated. As current passes through the at least one heating wire 311 via the first lead 312 and the second lead 313, the at least one heating wire 311 provides resistance, causing the at least one heating wire 311 to heat up. The thermal energy produced by the at least one heating wire 311 is then dissipated through the heater body 310, wherein the thermal energy is used to heat the substances placed within the heating chamber 32.

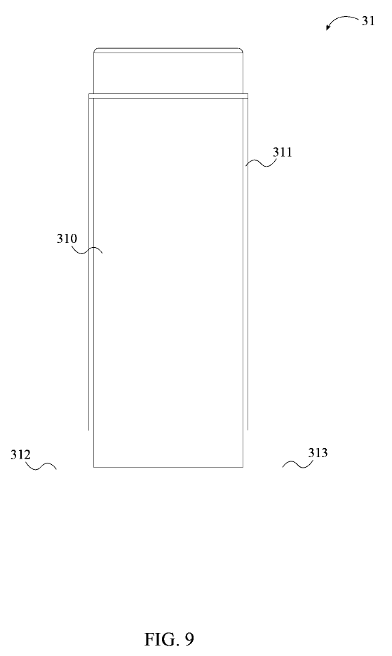

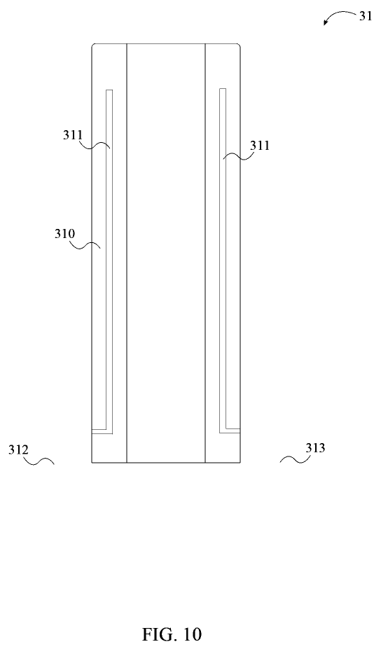

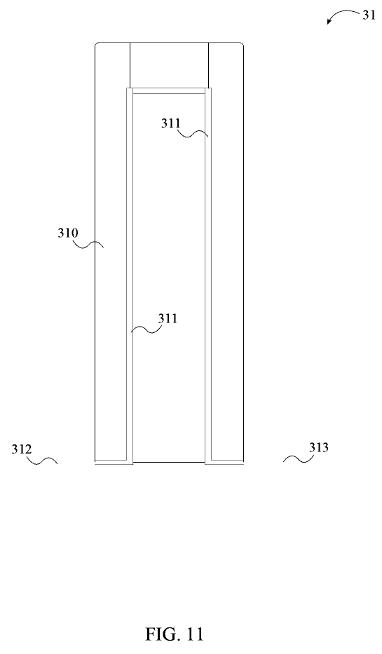

The at least one heating wire 311 may be fully enveloped within the heater body 310 as shown in FIG. 9, embedded into the inner surface of the heater body 310 as shown in FIG. 10, or embedded into the outer surface of the heater body 310 as shown in FIG. 11. Ideally, the at least one heating wire 311 is fully embedded within the heater body 310, as the at least one heating wire 311 is protected against corrosion or degradation. This oxidation-proof design on the resistivity material of the at least one heating wire 311 aims to provided an extended lifespan for the heating element 31.

The first lead 312 and the second lead 313 are electrically connected to the battery pin 41 through a pair of holes in the heating chamber 32 and the lower heat insulator 33. The pair of holes of the heating chamber 32 is aligned with the pair of holes of the lower heat insulator 33, creating a direct path from the heating chamber 32 to the battery connector 40. In one embodiment of the present invention, the first lead 312 and the second lead 313 are thin elongated members that traverse through the pair of holes of the heating chamber 32 and the lower heat insulator 33, wherein the first lead 312 and the second lead 313 are directly connected to the battery pin 41. In another embodiment of the present invention, the first lead 312 and the second lead 313 are positioned within the heating chamber 32 and are electrically connected to the battery pin 41 through a pair of wires. The pair of wires traverses through the heating chamber 32 and the lower heat insulator 33, wherein each of the pair of wires is connected to the battery pin 41 and either the first lead 312 or the second lead 313.

In order to improve the efficiency and operation of the present invention, the heating element 31 may be specifically constructed from ceramic; however, the heating element 31 is not limited to such materials. Ceramics offer a number of desirable advantages when used to construct the heater body 310 (and the heating chamber 32), as ceramic materials have a low thermal conductivity, meaning that they do not easily lose heat. In this way, most of the thermal energy produced from the at least one heating wire 311 is retained by the heater body 310 and used to heat the substance within the heating chamber 32. Additionally, ceramic materials are easily and quickly heated to a desired temperature. Resultantly, the use of ceramics for both the heater body 310 and the heating chamber 32 is an efficient choice in the operation of the present invention.

Further benefits of ceramics include electrical insulation due to the low conductivity of ceramics. This protects users of the present invention from electric shocks (as the cartridge sleeve 10 is ideally constructed from steel or another metal). Ceramics also have absorption and emission characteristics that cause even heat emission, such that thermal energy is evenly dissipated within the heating chamber 32. and improved battery conservation; this affords greater battery life to users. In addition to longer lifespan, ceramics provide higher processing temperature capabilities and full flexibility for ease of installation. Due to these advantages, an embodiment of the present invention utilizes ceramic heaters that are compact, provide maximum surface area contact, are light weight, have high watt density, and have good thermal efficiency.

In reference to FIG. 2-3, the upper heat insulator 34 is positioned around the heating chamber 32 about the chamber opening 320. The upper heat insulator 34 acts to hold the heating chamber 32 in place within the cartridge sleeve 10, as well as thermally insulate the cartridge sleeve 10 from the heat produced by the heating element 31. The outer surface of the upper heat insulator 34 frictionally engages the inner surface of the cartridge sleeve 10 in order to securely hold the heating chamber 32 in place. Similar to the lower heat insulator 33, in the preferred embodiment of the present invention, the upper heat insulator 34 is constructed from silicone rubber; however, it is possible for the upper heat insulator 34 to be constructed from any other material(s).

In further reference to FIG. 2-3, the connector insert 50 is concentrically positioned within the cartridge sleeve 10 above the upper heat insulator 34, such that the heating assembly 30 is positioned in between the battery connector 40 and the connector insert 50. The connector insert 50 provides a means of connection between the electric heating cartridge and a mouthpiece. In the preferred embodiment of the present invention, the connector insert 50 provides a means of frictionally holding the mouthpiece in place, wherein the outer surface of the mouthpiece frictionally engages the inner surface of the connector insert 50. The outer surface of the connector insert 50 frictionally engages the inner surface of the cartridge sleeve 10, wherein the mouthpiece is securely held in place. In an alternative embodiment of the present invention, the connector insert 50 provides a female threaded portion that can be engaged by a male threaded portion of the mouthpiece. In addition to the means of connection described above, it is possible for the connector insert 50 to provide any other type of connection between the cartridge sleeve 10 and the mouthpiece.

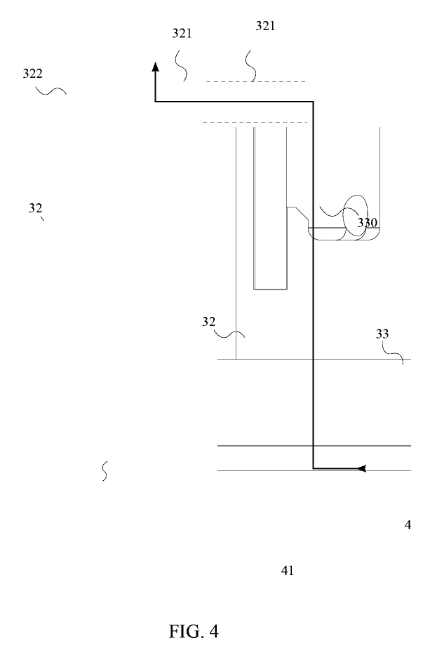

In order to use the present invention, the desired power source and mouthpiece are attached to the electric heating cartridge. Herbs are placed into the heating chamber 32 directly in contact with the exposed heating element 31. The plurality of airflow holes 321 of the heating chamber 32 is in fluid communication with the plurality of ventilation holes 11 through the at least one perimetric opening 330 and the perimeter gap 20, as depicted in FIG. 4. This allows air to enter the heating chamber 32 as the user inhales through the mouthpiece, wherein the air is mixed with the vapor of the active chemicals produced from the heating of the herbs within the heating element 31. The vapor and air mixture is then inhaled by the user through the mouthpiece.

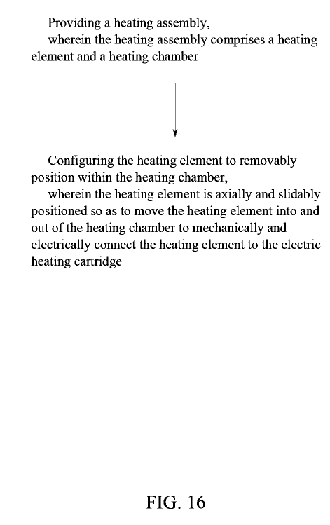

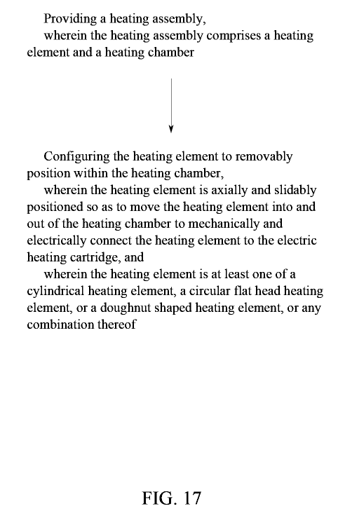

In reference to FIG. 16, the present invention also includes a method for providing an electric heating cartridge, wherein a heating assembly 30 is provided. The heating assembly 30 comprising a heating element 31 and a heating chamber 32. The heating element 31 is configured to be removably positioned within the heating chamber 32, wherein the heating element 31 is axially and slidably positioned so as to move the heating element 31 into and out of the heating chamber 32 to mechanically and electrically connect the heating element 31 to the electric heating cartridge. By configuring the heating element 31 to be removably positioned within the heating chamber 32, an electric heating cartridge is provided wherein the heating element 31 can be replaced, refurbished, etc. In reference to FIG. 17, the heating element 31 for providing the electric heating cartridge is at least one of a cylindrical heating element, a circular flat head heating element, or a doughnut shaped heating element, or any combination thereof.

Although the invention has been explained in relation to its preferred embodiment, it is to be understood that many other possible modifications and variations can be made without departing from the spirit and scope of the invention as hereinafter claimed.

What is claimed is:

1. An electric heating cartridge comprises:
a cartridge sleeve;
a perimeter gap;
a heating assembly;
a battery connector;
the cartridge sleeve comprises a plurality of ventilation holes;
the heating assembly comprises a heating element and a heating chamber;
the battery connector comprises a battery pin;
the heating chamber comprises a chamber opening and a plurality of airflow holes;
the cartridge sleeve, the perimeter gap, the heating assembly, and the battery connector being concentrically aligned with each other;
the heating assembly and the battery connector being positioned within the cartridge sleeve;
the heating assembly being positioned adjacent to the battery connector;
the perimeter gap being positioned in between the cartridge sleeve and the battery connector;
the plurality of ventilation holes being positioned around the cartridge sleeve adjacent to the perimeter gap;
the chamber opening being positioned about the heating chamber opposite the battery connector;
the plurality of airflow holes being positioned around the heating chamber opposite the chamber opening;
the plurality of airflow holes being in fluid communication with the plurality of ventilation holes through the perimeter gap;
the heating element being adjacently attached to the heating chamber opposite the chamber opening;
the heating element being concentrically positioned within the heating chamber; and
the heating element being electrically connected to the battery pin.

2. The electric heating cartridge as claimed in claim 1 comprises:
a connector insert;
the connector insert being concentrically positioned within the cartridge sleeve; and
the connector insert being positioned adjacent to the heating assembly opposite the battery connector.

3. The electric heating cartridge as claimed in claim 1 comprises:
the battery pin being concentrically positioned within the battery connector.

4. The electric heating cartridge as claimed in claim 1 comprises:
the battery connector further comprises a battery pin insulator;
the battery pin being concentrically positioned through the battery pin insulator; and
the battery pin being retained by the battery pin insulator.

5. The electric heating cartridge as claimed in claim 1 comprises:
the heating assembly further comprises a lower heat insulator; and
the lower heat insulator being positioned in between the battery connector casing and the heating chamber.

6. The electric heating cartridge as claimed in claim 1 comprises:
the heating assembly further comprises a lower heat insulator;
the lower heat insulator comprises an at least one perimetric opening; and
the at least one perimetric opening being in fluid communication with both the plurality of airflow holes and the perimeter gap.

7. The electric heating cartridge as claimed in claim 1 comprises:
the heating assembly further comprises an upper heat insulator;
the upper heat insulator being positioned in between the heating chamber and the cartridge sleeve; and
the upper heat insulator being positioned about the chamber opening.

8. The electric heating cartridge as claimed in claim 1, wherein the heating chamber
is ceramic.

9. The electric heating cartridge as claimed in claim 1, wherein the heating element
is ceramic.

10. The electric heating cartridge as claimed in claim 1, wherein the battery connector
is internally threaded opposite the heating assembly.

11. The electric heating cartridge as claimed in claim 1 comprises:
the heating element comprises a heater body and an at least one heating wire;
the heater body being adjacently attached to the heating chamber; and
the at least one heating wire being embedded in the heater body.

12. The electric heating cartridge as claimed in claim 11 comprises:
the heating element comprises a first lead and a second lead;
the at least one heating wire being adjacently connected to both the first lead and the second lead; and
the first lead and the second lead being electrically connected to the battery pin.

13. The electric heating cartridge as claimed in claim 1 comprises:
the heating chamber further comprises a heater mount;
the heating element comprises a heater body;
the heater mount being concentrically positioned within the heating chamber opposite the chamber opening; and
the heater body being adjacently connected to the heater mount.

14. The electric heating cartridge as claimed in claim 1, wherein the heating element is removable, whereby the heating element is axially and slidably positioned within the heating chamber.

15. The electric heating cartridge as claimed in claim 14, wherein the heating element is slidably positioned into and out of the heating chamber to mechanically and electrically connect the heating element to the electric heating cartridge.

16. The electric heating cartridge as claimed in claim 1, wherein the heating element is a cylindrical heating element.

17. The electric heating cartridge as claimed in claim 1, wherein the heating element is a circular flat head heating element.

18. The electric heating cartridge as claimed in claim 1, wherein the heating element is a doughnut shaped heating element.

19. A method for providing an electric heating cartridge, the method comprising:
providing a cartridge sleeve the cartridge sleeve comprises a plurality of ventilation holes;
providing a perimeter gap, positioning the perimeter gap in between the cartridge sleeve and the battery connector,
the plurality of ventilation holes being positioned around the cartridge sleeve adjacent to the perimeter gap so as at least one perimetric opening being in fluid communication with both a plurality of airflow holes and the perimeter gap,
the battery connector comprises a battery pin:
providing a heating assembly, wherein the heating assembly comprises a heating element and a heating chamber, the heating chamber comprises a chamber opening and a plurality of airflow holes;
concentrically aligned the cartridge sleeve, the perimeter gap, the heating assembly, and the battery connector;
positioning the heating assembly adjacent to the battery connector within the cartridge sleeve;
configuring the heating element to removably position within the heating chamber, wherein the heating element is axially and slidably positioned so as to move the heating element into and out of the heating chamber to mechanically and electrically connect the heating element to the electric heating cartridge;
the plurality of ventilation holes being positioned around the cartridge sleeve adjacent to the perimeter gap;
the chamber opening being positioned about the heating chamber opposite the battery connector;
the plurality of airflow holes being positioned around the heating chamber opposite the chamber opening;
the heating element being adjacently attached to the heating chamber opposite the chamber opening;
the heating element being concentrically positioned within the heating chamber; and
the heating element being electrically connected to the battery pin.

20. The method for providing an electric heating cartridge, the method as claimed in claim 19, wherein the heating element is at least one of a cylindrical heating element, a circular flat head heating element, or a doughnut shaped heating element, or any combination thereof.
